(19) United States
(12) Patent Application Publication
(10) Pub. No.: US 2017/0235035 A1
(43) Pub. Date: Aug. 17, 2017

(54) LIGHT PIPE TEXTURING INTENSITY GRADIENT FOR ELECTRONIC DEVICES

(71) Applicant: THOMSON LICENSING, Issy-les Moulineaux (FR)

(72) Inventors: Christopher Michael William PROCTOR, Westfield, IN (US); Vincent MALLET, Paris (FR)

(21) Appl. No.: 15/123,070

(22) PCT Filed: Mar. 18, 2015
(86) PCT No.: PCT/US2015/021270

§ 371 Date: Sep. 1, 2016

(30) Foreign Application Priority Data
Mar. 18, 2014 (EP) 14305381.7

(51) Int. Cl. F21V 8/00

(52) U.S. Cl. CPC G02B 6/0001

(57) ABSTRACT

The invention is an illumination system for a logo (20) on the front of an electronic device (1) such as a set top box. The logo (20) is part of a light pipe (23) and the logo (20) is illuminated by projecting light on the front surface (24) of the light pipe (23). The front surface (24) is textured or tinted to evenly distribute the light to a viewer. The light source (11) for illuminating the logo (20) is positioned at an entrance end of the light pipe (23) as shown in the figure. The shape of the light pipe (23) is substantially uniform throughout the length of the light pipe (23) and the shape is substantially the shape of the logo (20). The light pipe (23) can have a cut away region near the front surface to create localized lighting contrasts.

### CROSS-REFERENCE TO RELATED APPLICATIONS

This application claims the benefit of the priority of European Application 14305381.7 filed Mar 18, 2014.

### TECHNICAL FIELD

The present principles relate generally to electronic devices and, more particularly, to an electronic device having a light pipe for illuminating logos.

### BACKGROUND

Many manufacturers and consumers prefer that electronic devices have logos, buttons, and indicator signals which are illuminated such that the products can be identified, active buttons on the products can be identified, and the status of the device can be visually signaled to the user, respectively. Unfortunately, the illumination of such features adds costs to devices and also requires that some additional volume within the device be dedicated to support the illumination. Additionally, some manufactures require and/or prefer aesthetically pleasing visual effects for these features (i.e. logos, buttons, and indicator signals) to make the product more attractive, more marketable, and/or more identifiable to a particular manufacturer. Enhanced visual effects adds additional costs and product manufacturing steps.

One effect that manufacturers like to employ is to have a varying texture for the logos, buttons, and indicator signals across the perceived front surface which could be the exit plane of a light pipe. One way to implement texturing in systems is to employ a plurality of light emitting devices positioned at the entrance end of the light pipe and having the light emitting devices emit light at various particular angles into the light pipe to cause controlled nonuniformity at the exit end of the light pipe. In order to obtain the proper or desired effect, the side surfaces along sidewalls between the entrance and exit ends of the light pipes also have to be angled differently in different locations to obtain the proper light distribution.

Because the prior attempts to obtain varying texture for the logos, buttons, and indicator signals have been cumbersome and require complicated light pipe designing, a simple texture control approach is needed.

In addition, it is preferable that such a simple texture approach be able to effectively provide different textures for different portions of a logo for a set top box without the need for applying special coloring steps for the different portions of the logo.

### SUMMARY

One aspect of the invention is an illumination system for a logo on the front of an electronic device such as a set top box. The logo is part of a light pipe and the logo is illuminated by projecting light on the front surface of the light pipe. The front surface can be textured or tinted to evenly distribute the light to a viewer. Texture implies a level of roughness or smoothness of a surface. The light source for illuminating the logo is positioned at an entrance end of the light pipe. The shape of the light pipe can be substantially uniform throughout the length of the light pipe and the shape can be substantially the shape of the logo. The shape along the length of the light pipe can have a constant area or can change gradually to slightly flare. The light pipe can have a cut away region near the front surface to create a lighting effect in the cut away region different than other regions of the front surface.

An embodiment of the invention can be described as an electronic device that includes a casing having front wall (9); an aperture (21) on the front wall; a light pipe (23) having a plan view front surface (24) and a light entrance surface (28) in which the light pipe has an elongated body between the plan view front surface (24) and a light entrance surface (28), the elongated body has a constant shape that is constant along a length of the an elongated body, the plan view front surface is viewable through the aperture. The light pipe can further include a main optical area (25) and a secondary optical area (26) forming the plan view front surface in which the secondary optical area is adjacent the main optical area and setback from the main optical area. The device further includes a backlight light assembly (11) facing the light entrance surface to cause light to propagate into the light pipe. The main optical area can be planar or have a slight curvature and can be parallel or generally parallel to the front wall. The secondary optical area extends back from a perimeter region of the main optical area to a perimeter of the elongated body. The elongated body can have a constant front plan view area along the length and an area of the main optical area can be less than the constant front plan view area.

The plan view front surface can form at least one alphanumerical character and the at least one alphanumerical character can form a logo in which the main optical area has at least one texture and the secondary optical region has another texture that is different than the at least one texture when the plan view front surface is viewed from a plan view perspective.

In another implementation, the plan view front surface can be an actuation button in which the main optical area has at least one texture and the secondary optical region has another texture that is different than the at least one texture when the plan view front surface is viewed from a plan view perspective.

In other implementations, the plan view front surface can also be an indicator signal that indicates that activation of a function in which the main optical area has at least one texture and the secondary optical region has another texture that is different than the at least one texture when the plan view front surface is viewed from a plan view perspective.

The plan view front surface can be uncoated in one embodiment and in other embodiments the plan view front surface is textured with stippled in which the main optical area has at least one texture and the secondary optical region has another texture that is different than the at least one texture when the plan view front surface is viewed from a plan view perspective.

Another implementation involves the main optical area having at least one texture and the secondary optical region having another texture that is different than the at least one texture when the plan view front surface is viewed from a plan view perspective.

Additionally, the main optical area can have at least one color and the secondary optical region has another color that is different than the at least one color.

In a further implementation, the main optical area can have at least one light intensity when the backlight is on and the secondary optical region has another light intensity that is less than at least one light intensity when the backlight is on and when the plan view front surface is viewed from a plan view perspective.

### BRIEF DESCRIPTION OF THE DRAWINGS

The present principles may be better understood in accordance with the following exemplary figures, in which:

FIG. 1 shows a perspective view of an electronic device 1 with some elements thereof shown outside of the electronic device, in accordance with an embodiment of the present principles;

FIG. 2 shows a plan front view of the light pipe 23, in accordance with an embodiment of the present principles; and

FIG. 3 shows a perspective see-through view of the light pipe 23 and light source 11, in accordance with an embodiment of the present principles.

### DETAILED DESCRIPTION

The present principles are directed to an electronic device having textured logos, buttons, and/or indicator signals.

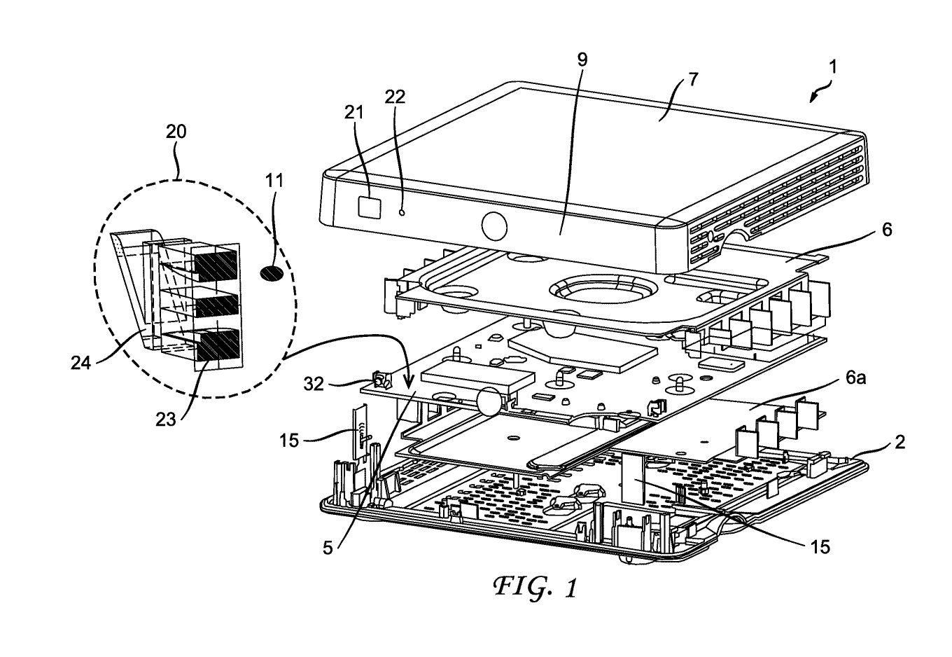

FIG. 1 further shows an electronic device 1 having a logo, button or indicator signal assembly 20 and how it can be positioned in the electronic device 1 which can be a set top box. The assembly 20 includes a backlight 11 and a light pipe 23. The front surface 24 of the light pipe 23 is positioned at the aperture 21 of a front wall of the device 1. An additional light indicator 22 which can be a “record” light can also be present. FIG. 1 shows that the assembly 20 can be positioned near or over a printed circuit board (pcb) 5. The backlight 11 can be positioned on the pcb 5 and be positioned behind the light pipe 23 and the front wall 9. The electronic device 1 can include a flange which can have peripheral portion or planar peripheral portion defining the shape of the aperture 21 through which the front surface 24 of the light pipe 23 is viewed. The assembly 20 can be designed to be button that can be pressed by a finger and activated by applying pressure on an actuator 32 which a rear portion of the light pipe can touch.

The light pipe 23 is provided which can be solid translucent or transparent light pipe that transmits light and when the light pipe is used as button, it can move and/or apply pressure to the switch actuator 32 when the assembly 20 is pressed by a user through or at aperture 21. The light from the backlight 11 enters the light pipe 23 reflects off of interior surfaces to propagate toward the front surface 24 of the light pipe 23. The light pipe 23 if translucent can also scatter light down toward the front surface 24.

The device 1 in which the assembly 20 can be employed will now be described in more detail. The device can be in a thin horizontally oriented set top box with a plastic case forming an enclosure around internal electronics such as a printed circuit board (pcb) and heatsinks as shown in FIG. 1. FIG. 1 is a view of a set top box that can incorporate features of the invention. As illustrated in the figure, a main circuit board 5 can be housed within a top cover 7. A thermal barrier (not shown) can be positioned between the circuit board 5 and a bottom frame 2. A smart card reader (not shown) can be connected to the circuit board 5 through an aperture in the thermal barrier. The device 1 can have internal components such as smart card reader, the thermal barrier, the circuit boards, a top heat sink 6 that contacts the circuit board 5 and is positioned between the bottom frame 2 and the top cover 7, and bottom heat sink 6a under the circuit board. Either or both heat sinks can include vertical fins at either opposing ends to promote heat dissipation in which some of the heat can be heat produced by the source 11. The device can include antenna assemblies 15 being positioned outside the periphery of the printed circuit board. The light pipe shape, color, and/or texture can signify and identify the presence and/or use of internal features, components, and functions of the device 1.

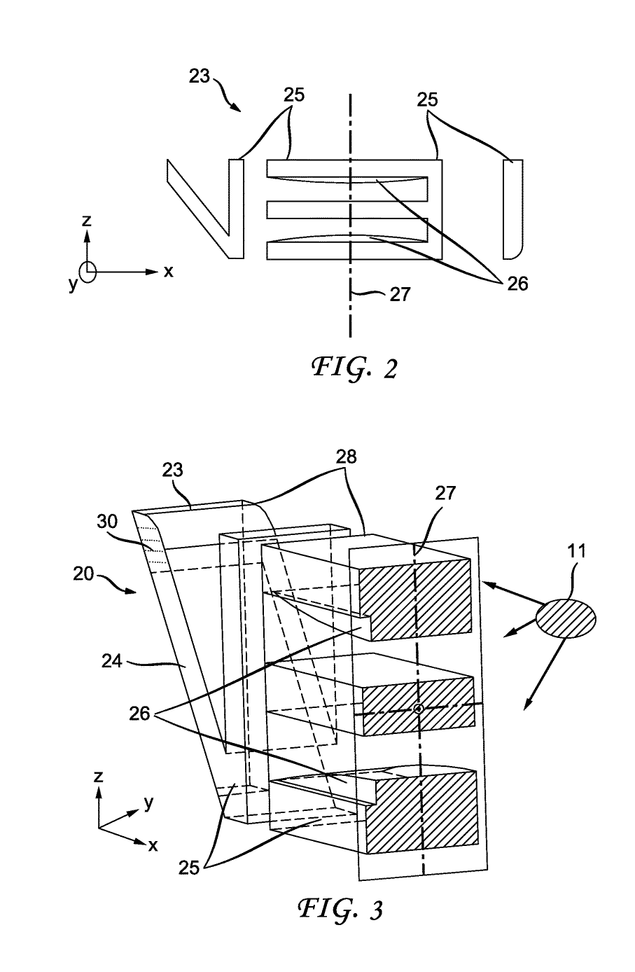

FIG. 2 shows a plan view of an example logo, button or indicator signal assembly 20 according to the invention. This view shows the front surface 24 of the light pipe 23 which can be seen through aperture 21 of device 1. FIG. 2 shows two separate optical plan view areas. The main texture area 25 is a region in which the front surface is planar and can show a constant texture, uniform intensity of light or a constant uniform color of light. In this example, the slanted “V,” the reverse “E,” and the “I” each have the main texture area 25. The spaces between these separate symbols can be opaque or hollow or empty. In this example the “V” and the “I” have only a main texture area 25 and the reverse “E” has both a main texture area 25 and faded texture area 26. The faded texture area 26 is shown protruding from the bottom the top bar of the reverse “E” and protruding from the top of the bottom bar of the reverse “E.”

FIG. 3 shows a perspective see-through section view of the light pipe 23 of FIG. 2 in which the light pipe is cut along center plane 27. FIG. 3 shows the front surface 24 and the backlight 11 that provides light to the light pipe 23 to the entrance end 28 which can be opposite the front surface 24. This view shows that the light pipe 23 can be substantially uniform throughout length of the light pipe 23 and maintain the shape of logo, button or indicator signal. The faded texture area 26, which is shown protruding from the bottom of the top bar of the reverse “E” and protruding from the top of the bottom bar of the reverse “E,” is created by having cut away regions adjacent the front surface region which is planar; however, the front surface can include some slight smooth continuous curvature. The cut away region creates a visual effect of having a different and/or subtler texture compared to the main texture area 25. This visual effect is created by having the faded texture area 26 set back from the main texture area 25 on its own. In other words, the cut away region creates the faded texture area 26. However, enhanced contrast between the faded texture area 26 and the main texture area 25 by the application of texturing or tinting 30, which is represented by several lines on front surface 24, is consider an alternative embodiment of the invention. This texturing or tinting 30 is only shown in part of the surface and can be on different depth levels which means the texturing or tinting 30 can be in main texture area 25 and the faded texture area 26 and this the texturing or tinting 30 can be variable to achieve the look that the manufacturer prefers for their logo, button, or indicator signal.

The invention allows one to use a single LED as the backlight 11 to achieve different light intensities in one light pipe without the need for the use of a secondary process such as painting. In other words, the plan view region of the faded texture area 26 shown in FIG. 2 does not need to painted, because this region is cut away.

As mentioned above, one aspect of the invention is an illumination system for a logo on the front of an electronic device such as a set top box. The logo is part of a light pipe and the logo is illuminated by projecting light on the front surface of the light pipe. The front surface can by textured in which the texturing can be stipple or low depth grooves which can for example be on the order of microns to tenths of a millimeter on the front surface 24. The tinting can be a coating of paint or a lacquer with some pigment. Texturing of the light pipes can help diffuse light and spread it evenly over a given surface. The light source for illuminating the logo is positioned at an entrance end of the FIGS. 1 and 3. The shape of the light pipe is substantially uniform throughout the length of the light pipe and the shape is substantially the shape of the logo. The light pipe can have a cut away region near the front surface to create localized lighting contrasts. The cut away region can be set back in the order of millimeters from the main texture area.

In short, the idea is to create a difference in gradient between the two regions of the plan view front surface of the logo. This is performed by varying the levels of the surfaces to achieve different textures or optical appearance. This can be done in combination with applying different levels of texturing to the two regions 25, 26. The combination of the two achieves a different optical appearance or effect and even enhance the differences. The disadvantage of this design with purposeful texturing would be the additional costs associated with the use a texture tool and the related cost of employing secondary processes.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. Further, the present principles are applicable to any electronic device including, but not limited to, a set top box, computer, game console, DVD player, CD player or the like, where the electronic device is provided with the improved light pipe. All such changes and modifications are intended to be included within the scope of the present principles as set forth in the appended claims.

1. An electronic device (1), comprising:
a casing having front wall (9);
an aperture (21) on the front wall;
a light pipe (23) having a plan view front surface (24) and a light entrance surface (28), wherein the light pipe has an elongated body between the plan view front surface (24) and a light entrance surface (28), the elongated body has a constant shape that is constant along a length of the an elongated body, the plan view front surface is viewable through the aperture;
a main optical area (25) and a secondary optical area (26) forming the plan view front surface, wherein the secondary optical area is adjacent the main optical area and setback from the main optical area, wherein the main optical area has at least one texture and the secondary optical region has another texture that is different than the at least one texture when the plan view front surface is viewed from a plan view perspective; and
a backlight light assembly (11) facing the light entrance surface to cause light to propagate into the light pipe.

2. The electronic device of claim 1, wherein the main optical area is planar and parallel to the front wall.

3. The electronic device of claim 1, wherein the main optical area is planar and parallel to the front wall and the secondary optical area extends back from a perimeter region of the main optical area to a perimeter of the elongated body.

4. The electronic device of claim 1, wherein the elongated body has a constant front plan view area along the length and an area of the main optical area is less than the constant front plan view area.

5. The electronic device of claim 1, wherein the plan view front surface forms at least one alphanumerical character and the at least one alphanumerical character forms a logo.

6. The electronic device of claim 1, wherein the plan view front surface is an actuation button.

7. The electronic device of claim 1, wherein the plan view front surface is an indicator signal that indicates that activation of a function.

8. The electronic device of claim 1, wherein the plan view front surface is uncoated.

9. The electronic device of claim 8, wherein the plan view front surface is textured with stippled.

10. The electronic device of claim 1, wherein the constant shape of the elongated body is the same as the plan view shape of the plan view front surface.

11. The electronic device of claim 1, wherein the main optical area has at least one color and the secondary optical region has another color that is different than the at least one color.

12. The electronic device of claim 1, wherein the main optical area has at least one light intensity when the backlight is on and the secondary optical region has another light intensity that is less than at least one light intensity when the backlight is on and when the plan view front surface is viewed from a plan view perspective.

13. The electronic device of claim 10, wherein the plan view front surface forms at least one alphanumerical character and the at least one alphanumerical character forms a logo.

14. The electronic device of claim 10, wherein the plan view front surface is an indicator signal that indicates that activation of a function.

15. The electronic device of claim 10, wherein the constant shape of the elongated body is the same throughout the length of the elongated body.
